(19) United States
(12) Patent Application Publication
(10) Pub. No.: US 2002/0169236 A1
(43) Pub. Date: Nov. 14, 2002

(54) Decorative solid surfacing materials filled with ceramic microspheres

(76) Inventors: David G. Halterman, Tonawanda, NY (US); Clyde S. Hutchins, Boston, NY (US); Donald A. Sandusky, Wilmington, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 09/790,361

(22) Filed: Feb. 22, 2001

(51) Int. Cl. C08K 9/00

(52) U.S. Cl. 523/218; 523/200

(57) ABSTRACT

A solid surface material comprising a matrix of a resin with a filler of ceramic microspheres dispersed therein having improved scorch resistance, said ceramic microspheres being coated with a composition having functional groups which react with the resin of said matrix in formation of the solid surface material.

### BACKGROUND OF THE INVENTION

1. Field of Invention

This invention is directed toward improving properties of decorative solid surfacing materials such as scorch resistance and other physical properties such as resistance to stress cracking.

2. Description Of The Related Art Solid surfacing materials can be considered as a general designation for various types of materials used as building products, such as bathroom vanity tops, sinks, shower stalls and kitchen counter tops, for example; furniture; sanitary use; lining materials; and stationary small articles. Artificial marble encompasses cultured marble, onyx and solid surface materials typically comprising some kind of resin matrix and either with or without a filler present in the resin matrix. Solid surface materials are typically filled resin materials. Corian®, sold by E. I. du Pont de Nemours and Company, Wilmington, Del., (DuPont), is a solid surface material comprising an acrylic matrix filled with alumina trihydrate (ATH) and other fillers.

The prior art describes many filled polymer compositions. For example U.S. Pat. Nos. 3,847,865, U.S. 3,324,074, U.S. 3,663,493 and U.S. 4,085,246 describe acrylic polymers filled with inorganic particulate matter. However, currently, the solid surfacing market is non-differentiated with respect to scorch resistance for such materials. The prior art has not adequately addressed this matter.

Damage to a decorative surface caused by exposure to excessive heat can manifest itself in several ways. A densely crosslinked very brittle surface when contacted by a hot object can thermally crack as a result of the thermal shock imposed and the resulting stresses associated with differential thermal expansion. Other materials might not crack initially, however, on repeated thermal cycling between the glassy region and the rubbery region where many materials have significantly different coefficients of thermal expansion can cause the material to suffer fatigue cracking.

Another type of heat damage involves surface scorching due to contact with an excessively hot object. Here permanent damage is a consequence of noticeable discoloration, either yellowing as a result of polymer decomposition, or whitening due to the scattering of light caused by microscopic fissures which form at the matrix/filler interphase. Each of these three types of heat damage is permanent and cannot be easily repaired.

One of the most immediate and visually distressing types of permanent heat damage incurred by a solid surfacing material is surface scorching and the permanent discoloration that occurs when a hot object is placed upon the surfacing material and allowed to cool.

### SUMMARY OF THE INVENTION

In accordance with this invention, solid surface material having improved scorch resistance and other improved properties is provided. The solid surface material includes a matrix of at least one resin and a filler dispersed in the matrix. A preferred resin is an acrylic resin The filler consists of ceramic microspheres which have functional groups such as from a silane coating which have reacted with the resin matrix in formation of the solid surface material. Also the present invention is direct to a precursor to the solid material immediately prior to its solidification.

### DESCRIPTION OF THE PREFERRED EMBODIMENTS

The resins useful in the present invention are not specially limited as long as they can be formed into a solid surface material by curing. Examples of useful acrylic resins include various kinds of conventional acrylic group monomers, acrylic group partial polymers, vinyl monomers for copolymerization other than acrylic group monomers, or partial polymers. As the acrylic group monomer, (meth)acrylic ester is preferable.

An especially preferred polymer which meets all of the above properties is poly(methyl methacrylate). In a castable composition, it is often introduced as a syrup of polymer in methyl methacrylate monomer. Methods of preparing such a syrup are described in the prior art. Another method of preparing a syrup is to simply dissolve polymer in the monomer. This latter method is quite useful for adjusting viscosity of the castable composition since molecular weight of polymer as well as concentration can be varied in such a way as to control the rheology.

The amount of fluid polymerizable constituent in the castable composition is typically at least 30% by volume. Methyl methacrylate monomer is preferred as a major constituent.

Other monomers useful as fluid polymerizable constituents are alkyl acrylates and methacrylates in which the alkyl groups can be from 1-18 carbon atoms, but preferably 1-4 carbon atoms. Suitable acrylic monomers are methyl acrylate; ethyl acrylate and methacrylate; n-propyl and i-propyl acrylates and methacrylates; n-butyl, 2-butyl, i-butyl and t-butyl acrylates and methacrylates; 2-ethylhexyl acrylate and methacrylate; cyclohexyl acrylate and methacrylate; omega,-hydroxyalkyl acrylates and methacrylates; N,N-dialkylaminoalkyl acrylates and methacrylates; N-[t-butyl] aminoethyl acrylate and methacrylate, etc.

Other unsaturated monomers include such compounds as bis-[beta-chloroethyl] vinylphosphonate; styrene; vinyl acetate; acrylonitrile; methacrylonitrile; acrylic and methacrylic acids; 2-vinyl- and 4-vinylpyridines; maleic acid, maleic anhydride and esters of maleic acid; acryl amide and methacrylamide; itaconic acid, itaconic anhydride and esters of itaconic acid and multifunctional monomers for crosslinking purposes such as unsaturated polyesters; alkylene diacrylates and dimethacrylates; allyl acrylate and methacrylate; N-hydroxymethylacrylamide and N-hydroxymethylmethacrylamide; N,N′-methylene diacrylamide and dimethacrylamide; glycidyl acrylate and methacrylate; diallyl phthalate; divinylbenzene; divinyltoluene; trimethylolpropane triacrylate and trimethacrylate; pentaerythritol tetraacrylate and tetramethacrylate; triallyl citrate and triallyl cyanurate.

The ceramic microspheres must be small so as not to be seen as a distinct phase in the polymer and impart scorch resistance to the fabricated decorative surfacing material. It has been found that the microspheres should be solid and have a diameter in the range of about 2 to 40 microns, preferably 2 to 5 microns.

The silane treated ceramic microspheres may be present in amounts from about 20 to about 65%, preferably about 50%, by weight based on the total weight of the material. The size and composition of the microspheres must be carefully controlled in order to obtain the benefits of this invention. The presence of significant amounts of other commonly known fillers detract from the advanticious anti-scorching attributes of the products of this invention. Accordingly, the products of this invention should be substantially free of such fillers. However, controlled amounts of additives such as pigments, dyes, flame retardant agents, impact modifiers, parting agents, fluidizing agents, viscosity control agents, curing agents, antioxidants, and the like as known to those of ordinary skill in the art may be added. Such additives may be included in amounts that do not detract from the anti-scorching attributes of the products of this invention.

The ceramic microspheres useful in this invention must be coated with a composition having functional groups which are reactive with the polymer of the resin matrix. Silane compositions are preferred. Such microspheres are available from commercial sources or may be prepared by known coating methods. For example, silane coated microspheres, A 174, are available from the 3M Corporation. Ceramic microspheres having coating containing functional groups such as epoxy, carboxylic acid, anhydride, hydroxy, ester, acid chloride, amino, vinyl and mercapto are useful.

Solid surface materials of this invention are typically produced by casting into a sheet form or casting into a shape such as a sink, for example. A suitable cross linking agent is included with other ingredients which are introduced into a reactor. Solid surface materials of this invention can also be produced by, for example, compression molding, injection molding or extrusion. These materials have restorable, i.e. renewable surfaces, improved mechanical properties such as work to break, and improved resistance to thermal stress cracking as will be illustrated in the following Examples in which parts and percentages are by weight unless otherwise indicated.

### EXAMPLE 1

A 2000 mL reaction kettle (13×17 cm) fitted with a Neoprene® (E.I.duPont de Nemours & Co.) O-Ring is assembled with a reactor top having ports for a temperature probe, air-driven stirrer, rubber septum and an Allihn type reflux condenser. The following ingredients were sequentially weighed into the reactor:

| | | |
|---|---|---|
| PMA-25 (t-Butyl Peroxymaleic Acid Paste) | 9.49 | g |
| Titanium Dioxide Pigment Paste | 12.51 | g |
| ULMB (Ultra-Marine Blue) Pigment Paste | 0.19 | g |
| Aerosol-OT (dioctyl sodium sulfosuccinate) | 2.05 | g |
| TRIM (Trimethylolpropane Trimethacrylate | 6.33 | g |
| Prepolymer Syrup (24% Solution of PMMA in MMA) | 777.84 | g |

After mixing these ingredients using a High Speed Disperser (HSD) Blade (60 mm Diameter—INDCO Cowles Type) at 500 rpm for one minute at room temperature, 815 g of W410 Zeeospheres® (product of 3 M Corp.) (previously treated with 0.25 wt % 2-Trimethoxysilyl) Propyl Methacrylate) was added portionwise over a two minute interval. During the portionwise addition of the Zeeospheres® the revolutions per minute (rpm) of the HSD was incrementally increased to about 1500 rpm.

After the Zeeosphere® addition was complete, the HSD speed was increased to 2000 rpm and maintained for 10 minutes. After this time, the mix was re-weighed and about 5.0 g of MMA monomer (methyl methacrylate) was added replenishing MMA lost due to evaporation. The mix was then evacuated (Reflux condenser cooled to −10° C.) at 75 Torr (about 27 inches of Hg) for two minutes with 1000 rpm stirring (3″-four blade prop). The vacuum was released with air, then a 90 g aliquot was withdrawn for viscosity measurement. The Brookfield viscosity (DVII+; spindle #T-D; ⁶⁰ rpm) was 700 cps.

The mix was re-evacuated to 75 Torr (about 27 inches of Hg) with stirring (1000 rpm; four-blade prop), and then gently warmed to 28° C. using a waterbath. Mixing rpm was increased to 1500 rpm and the following ingredients were sequentially injected in rapid succession:

De-mineralized water—2.21 g—using a 3 cc Syringe through the septum

Calcium Hydroxide Dispersion—2.89 g—using a 10 cc Syringe through the septum in Butyl Methacrylate monomer

GDMA (Glycol Dimercaptoacetate)—49 g—using a 3 cc Syringe through the septum

The addition of the GDMA was considered “Time Zero”. The slurry was mixed at 1500 rpm at 28° C. for about 30 sec. Mixing was discontinued and the vacuum released in rapid succession. The activated mix was gently swirled (to avoid skinning) and poured into a 12.6 mm sheet casting mold within a one minute interval. The hardened, polymerized composite plaque was removed from the mold after about one hour.

The product recovered exhibited excellent resistance to surface scorching, excellent mechanical properties such as work to break, and resistance to thermal stress cracking.

### EXAMPLE 2

A 2000 mL reaction kettle (13×17 cm) fitted with a Neoprene® (E.I.du Pont de Nemours & Co.) O-Ring was assembled with a reactor top having ports for a temperature probe, air-driven stirrer, rubber septum and an Allihn type reflux condenser. The following ingredients were sequentially weighed into the reactor:

| | | |
|---|---|---|
| PMA-25 (t-Butyl Peroxymaleic Acid Paste) | 7.25 | g |
| Pearl Gray Pigment Paste | 0.26 | g |
| Aerosol-OT | 0.60 | g |
| TRIM (Trimethylolpropane Trimethacrylate) | 2.39 | g |
| Prepolymer Syrup (24% Solution of PMMA in MMA) | 260.58 | g |
| Zelec ® MO phosphated propylene glycol methacrylate | 0.54 | g |

After mixing these ingredients using a High Speed Disperser (HSD) Blade (60 mm Diameter—INDCO Cowles Type) at 500 rpm for one minute at room temperature, 198.5 g of W410 Zeeospheres® (previously treated with 0.25 wt % 2-(Trimethoxysilyl) Propyl Methacrylate) to provide 40 weight % microspheres was added portionwise over a two minute interval. During the portionwise addition of the Zeeospheres® the rpm of the HSD was incrementally increased to about 1500 rpm.

After the Zeeosphere® addition was complete, the HSD speed was increased to 2000 rpm and maintained for 10 minutes. After this time, the mix was re-weighed and about 5.0 g of MMA monomer (methyl methacrylate) was added replenishing MMA lost due to evaporation. The mix was then evacuated (Reflux condenser cooled to −10° C.) at 75 Torr (about 27 inches of Hg) for two minutes with 1000 rpm stirring (3′-four blade prop). The vacuum was released with air, then a 90 g aliquot was withdrawn for viscosity measurement. The Brookfield viscosity (DVII+; spindle #T-D; 60 rpm) was 500 cps.

The mix was re-evacuated to 75 Torr (about 27 inches of Hg) with stirring (1000 rpm; four-blade prop), then gently warmed to 28° C. using a waterbath. Mixing rpm was increased to 1500 rpm and the following ingredients were sequentially injected in rapid succession:

De-mineralized water—0.84 g—using a 3 cc Syringe through the septum

Calcium Hydroxide Dispersion—2.18 g—using a 10 cc Syringe through the septum in Butyl Methacrylate monomer

GDMA (Glycol Dimercaptoacetate)—1.14 g—using a 3 cc Syringe through the septum

The addition of the GDMA was considered “Time Zero”. The slurry was mixed at 1500 rpm at 28° C. for about 30 sec. Mixing was discontinued and the vacuum released in rapid succession. The activated mix was gently swirled (to avoid skinning) and poured into a 12.6 mm sheet casting mold within a one minute interval. The time required to achieve a peak temperature of 158° C. was 5.3 minutes. After cooling, the hardened, polymerized composite plaque was removed from the mold after about one hour.

The product recovered exhibited excellent resistance to surface scorching, excellent mechanical properties such as work to break, and resistance to thermal stress cracking.

### EXAMPLE 3

A 200 mL reaction kettle (13×17 cm) fitted with a Neoprene® O-Ring is assembled with a reactor top having ports for a temperature probe, air-driven stirrer, rubber septum and an Allihn type reflux condenser. The following ingredients were sequentially weighed into the reactor:

| | | |
|---|---|---|
| PMA-25 (t-Butyl Peroxymaleic Acid Paste) | 9.49 | g |
| Titanium Dioxide Pigment Paste | 12.51 | g |
| ULMB (Ultra-Marine Blue) Pigment Paste | 0.19 | g |
| Aerosol-OT | 2.05 | g |
| TRIM (Trimethylolpropane Trimethacrylate) | 6.33 | g |
| Prepolymer Syrup (24% Solution of PMMA in MMA) | 777.84 | g |

After mixing these ingredients using a High Speed Disperser (HSD) Blade (60 mm Diameter—INDCO Cowles Type) at 500 rpm for one minute at room temperature, 1050.0 g of W410 Zeeospheres (previously treated with 0.25 wt % 2-(Trimethoxysilyl) Propyl Methacrylate) to provide 50 weight % microspheres was added portionwise over a two minute interval. During the portionwise addition of the Zeeospheres® the rpm of the HSD was incrementally increased to about 1500 rpm.

After the Zeeosphere® addition was complete, the HSD speed was increased to 2000 rpm and maintained for 10 minutes. After this time, the mix was re-weighed and about 5.0 g of MMA monomer (methyl methacrylate) was added replenishing MMA lost due to evaporation. The mix was then evacuated (Reflux condenser cooled to −10° C.) at 75 Torr (about 27 inches of Hg) for two minutes with 1000 rpm stirring (3″-four blade prop). The vacuum was released with air, then a 90 g aliquot was withdrawn for viscosity measurement. The Brookfield viscosity (DVII+; spindle #T-D; 60 rpm) was 700 cps.

The mix was re-evacuated to 75 Torr (about 27 inches of Hg) with stirring (1000 rpm; four-blade prop), then gently warmed to 28° C. using a waterbath. Mixing rpm was increased to 1500 rpm and the following ingredients were sequentially injected in rapid succession:

De-mineralized water—2.21 g—using a 3 cc Syringe through the septum

Calcium Hydroxide Dispersion—2.89 g—using a 10 cc Syringe through the septum in Butyl Methacrylate monomer

GDMA (Glycol Dimercaptoacetate)—1.49 g—using a 3 cc Syringe through the septum

The addition of the GDMA was considered “Time Zero”. The slurry was mixed at 1500 rpm at 28° C. for about 30 sec. Mixing was discontinued and the vacuum released in rapid succession. The activated mix was gently swirled (to avoid skinning) and poured into a 12.6 mm sheet casting mold within a one minute interval. The polymerization entered an auto-acceleration phase at 55° C. after 7.0 minutes. The time required to achieve a peak temperature of 157° C. was 10.8 minutes. After cooling, the hardened, polymerized composite plaque was removed from the mold after about one hour.

The product recovered exhibited excellent resistance to surface scorching, excellent mechanical properties such as work to break, and resistance to thermal stress cracking.

### EXAMPLE 4

A 200 mL reaction kettle (13×17 cm) fitted with a Neoprene® O-Ring is assembled with a reactor top having ports for a temperature probe, air-driven stirrer, rubber septum and an Allihn type reflux condenser. The following ingredients were sequentially weighed into the reactor:

| | | |
|---|---|---|
| PMA-25 (t-Butyl Peroxymaleic Acid Paste) | 8.08 | g |
| Titanium Dioxide Pigment Paste | 16.12 | g |
| ULMB (Ultra-Marine Blue) Pigment Paste | 0.25 | g |
| Aerosol-OT | 2.64 | g |
| TRIM (Trimethylolpropane Trimethacrylate) | 5.38 | g |
| Prepolymer Syrup (24% Solution of PMMA in MMA) | 661.92 | g |

After mixing these ingredients using a High Speed Disperser (HSD) Blade (60 mm Diameter—INDCO Cowles Type) at 500 rpm for one minute at room temperature, 1050.0 g of W410 Zeeospheres® (previously treated with 0.25 wt % 2-(Trimethoxysilyl) Propyl Methacrylate) to provide 60 weight % microspheres was added portionwise over a two minute interval. During the portionwise addition of the Zeeospheres® the rpm of the HSD was incrementally increased to about 1500 rpm.

After the Zeeosphere® addition was complete, the HSD speed was increased to 2000 rpm and maintained for 10 minutes. After this time, the mix was re-weighed and about 5.0 g of MMA monomer (methyl methacrylate) was added replenishing MMA lost due to evaporation. The mix was then evacuated (Reflux condenser cooled to −10° C.) at 75 Torr (about 27 inches of Hg) for two minutes with 1000 rpm stirring (3″-four blade prop). The vacuum was released with air, then a 90 g aliquot was withdrawn for viscosity measurement. The Brookfield viscosity (DVII+; spindle #T-D; 60 rpm) was 2000 cps.

The mix was re-evacuated to 75 Torr (about 27 inches of Hg) with stirring (1000 rpm; four-blade prop), then gently warmed to 28° C. using a waterbath. Mixing rpm was increased to 1500 rpm and the following ingredients were sequentially injected in rapid succession:

De-mineralized water—1.88 g—using a 3 cc Syringe through the septum

Calcium Hydroxide Dispersion—2.46 g—using a 10 cc Syringe through the septum in Butyl Methacrylate monomer

GDMA (Glycol Dimercaptoacetate)—1.27 g—using a 3 cc Syringe through the septum

The addition of the GDMA was considered “Time Zero”. The slurry was mixed at 1500 rpm at 28° C. for about 30 sec. Mixing was discontinued and the vacuum released in rapid succession. The activated mix was gently swirled (to avoid skinning) and poured into a 12.6 mm sheet casting mold within a one minute interval. The polymerization entered an auto-acceleration phase at 51° C. after 6.0 minutes. The time required to achieve a peak temperature of 145° C. was 12.8 minutes. After cooling, the hardened, polymerized composite plaque was removed from the mold after about one hour.

The product recovered exhibited excellent resistance to surface scorching, excellent mechanical properties such as work to break, and resistance to thermal stress cracking.

### EXAMPLE 5

A 2000 mL reaction kettle (13×17 cm) fitted with a Neoprene® O-Ring is assembled with a reactor top having ports for a temperature probe, air-driven stirrer, rubber septum and an Allihn type reflux condenser. The following ingredients were sequentially weighed into the reactor:

| | | |
|---|---|---|
| PMA-25 (t-Butyl Peroxymaleic Acid Paste) | 16.04 | g |
| Titanium Dioxide Pigment Paste | 11.23 | g |
| ULMB (Ultra-Marine Blue) Pigment Paste | 0.18 | g |
| Aerosol-OT | 2.55 | g |
| TRIM (Trimethylolpropane Trimethacrylate) | 4.87 | g |
| Prepolymer Syrup (24% Solution of PMMA in MMA) | 325.34 | g |

After mixing these ingredients using a High Speed Disperser (HSD) Blade (60 mm Diameter—INDCO Cowles Type) at 500 rpm for one minute at room temperature, 736.0 g of W410 Zeeospheres® (previously treated with 0.25 wt % 2-(Trimethoxysilyl) Propyl Methacrylate) was added portionwise over a two minute interval. During the portionwise addition of the Zeeospheres® the rpm of the HSD was incrementally increased to about 1500 rpm.

After the Zeeosphere® addition was complete, the HSD speed was increased to 2000 rpm and maintained for 10 minutes. MMA monomer (208.0 g) was added followed by the portionwise, sequential addition of ground-up Glacier White Corian® polyester (248 g; 30-150 mesh particle size) and ground-up Black Quartz Corian® polyester (40 g; 30-150 mesh particle size). Over an interval of about five minutes, the mix was re-evacuated to 75 Torr (about 27 inches of Hg) with stirring (1000 rpm; four-blade prop), then gently warmed to 28° C. using a waterbath. Mixing rpm was increased to 1500 rpm and the following ingredients were sequentially injected in rapid succession:

De-mineralized water—1.82 g—using a 3 cc Syringe through the septum

Calcium Hydroxide Dispersion—3.45 g—using a 10 cc Syringe through the septum in Butyl Methacrylate monomer

GDMA (Glycol Dimercaptoacetate)—2.52 g—using a 3 cc Syringe through the septum

The addition of the GDMA was considered “Time Zero”. The slurry was mixed at 1500 rpm at 28° C. for about 30 sec. Mixing was discontinued and the vacuum released in rapid succession. The activated mix was gently swirled (to avoid skinning) and poured into a 12.6 mm sheet casting mold within a one minute interval. The polymerization entered an auto-acceleration phase at 67° C. after 4.0 minutes. The time required to achieve a peak temperature of 139° C. was 6.0 minutes. After cooling, the hardened, polymerized composite plaque was removed from the mold after about one hour.

The product recovered exhibited excellent resistance to surface scorching, excellent mechanical properties such as work to break, and resistance to thermal stress cracking.

### EXAMPLE 6

A 200 mL reaction kettle (13 cm×17 cm) fitted with a Neoprene® O-Ring was assembled with the reactor top having ports for a temperature probe, air-driven stirrer, rubber septum and an Allihn-type reflux condenser. The following ingredients were sequentially weighed into the reactor:

| | | |
|---|---|---|
| TRIM (Trimethylolpropane Trimethacrylate) | 4.77 | g |
| Prepolymer Syrup (20% Solution of Elvacite ® 2969 | 590.75 | g |
| acrylic resin (E. I. duPont de Nemours & Co.) | | |
| in methyl methacrylate | | |
| TiO₂ (Titanium Dioxide) Pigment Paste | 2.11 | g |
| ULMB (Ultra-Marine Blue) Pigment Paste | 0.06 | g |
| Lupersol ® 10M75 (t-Butyl Peroxyneodecanoate) | 1.91 | g |
| Vazo ® 67 peroxide initiator | 0.38 | g |

After mixing these ingredients using a High Speed Disperser (HSD) Blade (60 mm Diameter—INDCO Cowles Type) at 500 rpm for one minute at room temperature, 600 g of W410 Zeeospheres® (previously treated with 0.25 wt % 2-(Trimethoxysilyl) Propyl Methacrylate) to provide 50 weight % microspheres was added portionwise over a two minute interval. During the portionwise addition of the Zeeospheres® the rpm of the HSD was incrementally increased to about 1500 rpm.

After the Zeeosphere® addition was complete, the HSD speed was increased to 2000 rpm and maintained for 10 minutes. After this time, the mix was re-weighed and about 5.0 g of MMA monomer (methyl methacrylate) was added replenishing MMA lost due to evaporation. The mix was then evacuated (Reflux condenser cooled to −10° C.) at 75 Torr (about 27 inches of Hg) for two minutes with 1000 rpm stirring (7.6 cm-four blade prop). The vacuum was released with air, then a 90 g aliquot was withdrawn for viscosity measurement. The Brookfield viscosity (DVII+; spindle #T-D; 60 rpm; 25° C.) was 1000 cps.

The mix was poured into a casting mold constructed from two stainless metal plates (25.4 cm×25.4 cm×1.0 mm) separated by a Silastic® gasket (4.3 mm thickness). Each of the metal plates was coated with a Zonyl® UR external release coating. The casting mold was assembled using spring clamps. After bleeding a small amount of air from the cell, the sealed cell was submerged vertically in an 80° C. waterbath. Progress of the polymerization was monitored using a thermocouple inserted into the casting cell through the gasket. The polymerization entered an auto-acceleration phase at 83° C. after 10.0 minutes. The time required to achieve a peak temperature of 93° C. was 11.3 minutes. Twenty (20) minutes after the maximum temperature was attained, the casting cell was removed from the waterbath and placed in a 120° C. circulating hot air oven for sixty (60) minutes. After removing the cell from the hot air oven, the hardened, polymerized composite plaque was separated from the metal casting mold when the temperature of the composite had dropped below 50° C. (about one hour).

The product recovered exhibited excellent resistance to surface scorching, excellent mechanical properties such as work to break, and resistance to thermal stress cracking.

### EXAMPLE 7

A 200 mL reaction kettle (13 cm×17 cm) fitted with a Neoprene® O-Ring was assembled with the reactor top having ports for a temperature probe, air-driven stirrer, rubber septum and an Allihn-type reflux condenser. The following ingredients were sequentially weighed into the reactor:

| | | |
|---|---|---|
| TRIM (Trimethylolpropane Trimethacrylate) | 4.36 | g |
| Prepolymer Syrup (20% Solution of Elvacite ® 2969 | 518.24 | g |
| acrylic resin (E. I. duPont de Nemours & Co.) | | |
| in methyl methacrylate | | |
| nBA (n-Butyl Acrylate) | 17.46 | g |
| TiO₂ (Titanium Dioxide) Pigment Paste | 7.72 | g |
| ULMB (Ultra-Marine Blue) Pigment Paste | 0.12 | g |
| Lupersol ® 10M75 (t-Butyl Peroxyneodecanoate) | 1.75 | g |
| Vazo ® 67 peroxide initiator | 0.35 | g |

After mixing these ingredients using a High Speed Disperser (HSD) Blade (60 mm Diameter—INDCO Cowles Type) at 500 rpm for one minute at room temperature, 550 g of W410 Zeeospheres® (previously treated with 0.25 wt % 2-(Trimethoxysilyl) Propyl Methacrylate) to provide-50 weight % microspheres was added portionwise over a two minute interval. During the portionwise addition of the Zeeospheres® the rpm of the HSD was incrementally increased to about 1500 rpm.

After the Zeeosphere® addition was complete, the HSD speed was increased to 2000 rpm and maintained for 10 minutes. After this time, the mix was re-weighed and about 5.0 g of MMA monomer (methyl methacrylate) was added replenishing MMA lost due to evaporation. The mix was then evacuated (Reflux condenser cooled to −10° C.) at 75 Torr (about 27 inches of Hg) for two minutes with 1000 rpm stirring (7.6 cm-four blade prop). The vacuum was released with air, then a 90 g aliquot was withdrawn for viscosity measurement. The Brookfield viscosity (DVII+; spindle #T-D; 60 rpm; 25° C.) was 550 cps.

The mix was poured into a casting mold constructed from two stainless metal plates (25.4 cm×25.4 cm×1.0 mm) separated by a Silastic® gasket (4.3 mm thickness). Each of the metal plates was coated with a Zonyl® UR external release coating. The casting mold was assembled using spring clamps. After bleeding a small amount of air from the cell, the sealed cell was submerged vertically in an 80° C. waterbath. Progress of the polymerization was monitored using a thermocouple inserted into the casting cell through the gasket. The polymerization entered an auto-acceleration phase at 83° C. after 10.2 minutes. The time required to achieve a peak temperature of 96° C. was 11.6 minutes. Twenty (20) minutes after the maximum temperature was attained, the casting cell was removed from the waterbath and placed in a 120° C. circulating hot air oven for sixty (60) minutes. After removing the cell from the hot air oven, the hardened, polymerized composite plaque was separated from the metal casting mold when the temperature of the composite had dropped below 50° C. (about one hour).

The product recovered exhibited excellent resistance to surface scorching, excellent mechanical properties such as work to break, and resistance to thermal stress cracking.

### EXAMPLE 8

A 200 mL reaction kettle (13 cm×17 cm) fitted with a Neoprene® O-Ring was assembled with the reactor top having ports for a temperature probe, air-driven stirrer, rubber septum and an Allihn-type reflux condenser. The following ingredients were sequentially weighed into the reactor:

| | | |
|---|---|---|
| TRIM (Trimethylolpropane Trimethacrylate) | 5.24 | g |
| Prepolymer Syrup (20% Solution of Elvacite ® 2969 | 648.13 | g |
| acrylic resin (E. I. duPont de Nemours & Co.) | | |
| in methyl methacrylate | | |
| TiO₂ (Titanium Dioxide) Pigment Paste | 10.23 | g |
| ULMB (Ultra-Marine Blue) Pigment Paste | 0.20 | g |
| Lupersol ® 10M75 (t-Butyl Peroxyneodecanoate) | 2.38 | g |
| Vazo ® 67 peroxide initiator | 0.48 | g |

After mixing these ingredients using a High Speed Disperser (HSD) Blade (60 mm Diameter—INDCO Cowles Type) at 500 rpm for one minute at room temperature, 1000 g of W410 Zeeospheres® (previously treated with 0.25 wt % 2-(Trimethoxysilyl) Propyl Methacrylate) to provide 60 weight % microspheres was added portionwise over a two minute interval. During the portionwise addition of the Zeeospheres® the rpm of the HSD was incrementally increased to about 1500 rpm.

After the Zeeosphere® addition was complete, the HSD speed was increased to 2000 rpm and maintained for 10 minutes. After this time, the mix was re-weighed and about 5.0 g of MMA monomer (methyl methacrylate) was added replenishing MMA lost due to evaporation. The mix was then evacuated (Reflux condenser cooled to −10° C.) at 75 Torr (about 27 inches of Hg) for two minutes with 1000 rpm stirring (7.6 cm-four blade prop). The vacuum was released with air, then a 90 g aliquot was withdrawn for viscosity measurement. The Brookfield viscosity (DVII+; spindle #T-D; 60 rpm; 25° C) was 1750 cps.

The mix was poured into a casting mold constructed from two stainless metal plates (25.4 cm×25.4 cm×1.0 mm) separated by a Silastic® gasket (12.95 mm thickness). Each of the metal plates was coated with a Zonyl® UR external release coating. The casting mold was assembled using spring clamps. After bleeding a small amount of air from the cell, the sealed cell was submerged vertically in an 80° C. waterbath. Progress of the polymerization was monitored using a thermocouple inserted into the casting cell through the gasket. The polymerization entered an auto-acceleration phase at 109° C. after 10.5 minutes. The time required to achieve a peak temperature of 157° C. was 11.3 minutes. Twenty (20) minutes after the maximum temperature was attained, the casting cell was removed from the waterbath and placed in a 120° C. circulating hot air oven for sixty (60) minutes. After removing the cell from the hot air oven, the hardened, polymerized composite plaque was separated from the metal casting mold when the temperature of the composite had dropped below 50° C. (about one hour).

The product recovered exhibited excellent resistance to surface scorching, excellent mechanical properties such as work to break, and resistance to thermal stress cracking.

### EXAMPLE 9

A 200 mL reaction kettle (13 cm×17 cm) fitted with a Neoprene® O-Ring was assembled with the reactor top having ports for a temperature probe, air-driven stirrer, rubber septum and an Allihn-type reflux condenser. The following ingredients were sequentially weighed into the reactor:

| | | |
|---|---|---|
| TRIM (Trimethylolpropane Trimethacrylate) | 5.44 | g |
| Prepolymer Syrup (20% Solution of Elvacite ® 2969 | 475.29 | g |
| acrylic resin (E. I. duPont de Nemours & Co.) | | |
| in methyl methacrylate | | |
| MMA (Methyl Methacrylate) | 83.87 | g |
| nBA (n-Butyl Acrylate) | 19.77 | g |
| Zelec ® MO (phosphated methacrylate ester) | 4.96 | g |
| Aerosil ® 200 | 16.00 | g |
| Lupersol ® 10M75 (t-Butyl Peroxyneodecanoate) | 1.75 | g |
| Vazo ® 67 peroxide initiator | 0.35 | g |

After mixing these ingredients using a High Speed Disperser (HSD) Blade (60 mm Diameter—INDCO Cowles Type) at 500 rpm for one minute at room temperature, 992 g of W410 Zeeospheres® (previously treated with 0.25 wt % 2-(Trimethoxysilyl) Propyl Methacrylate) to provide 62 weight % microspheres was added portionwise over a two minute interval. During the portionwise addition of the Zeeospheres® the rpm of the HSD was incrementally increased to about 1500 rpm.

After the Zeeosphere® addition was complete, the HSD speed was increased to 2000 rpm and maintained for 10 minutes. After this time, the mix was re-weighed and about 5.0 g of MMA monomer (methyl methacrylate) was added replenishing MMA lost due to evaporation. The mix was then evacuated (Reflux condenser cooled to −10° C.) at 75 Torr (about 27 inches of Hg) for two minutes with 1000 rpm stirring (7.6 cm-four blade prop). The vacuum was released with air, then a 90 g aliquot was withdrawn for viscosity measurement. The Brookfield viscosity (DVII+; spindle #T-D; 60rpm; 25° C.) was 1500 cps.

The mix was poured into a casting mold constructed from two stainless metal plates (25.4 cm×25.4 cm×1.0 mm) separated by a Silastic® gasket (14 mm thickness). Each of the metal plates was coated with a Zonyl® UR external release coating. The casting mold was assembled using spring clamps. After bleeding a small amount of air from the cell, the sealed cell was submerged vertically in an 80° C. waterbath. Progress of the polymerization was monitored using a thermocouple inserted into the casting cell through the gasket. The polymerization entered an auto-acceleration phase at 1 10° C. after 10.8 minutes. The time required to achieve a peak temperature of 150° C. was 11.6 minutes. Twenty (20) minutes after the maximum temperature was attained, the casting cell was removed from the waterbath and placed in a 120° C. circulating hot air oven for sixty (60) minutes. After removing the cell from the hot air oven, the hardened, polymerized composite plaque was separated from the metal casting mold when the temperature of the composite had dropped below 50° C. (about one hour).

The product recovered exhibited excellent resistance to surface scorching, excellent mechanical properties such as work to break, and resistance to thermal stress cracking.

What is claimed is:

1. A solid surface material comprising a matrix of at least one resin and a ceramic microsphere filler dispersed in the matrix, said filler being coated with a composition having functional groups which react with the resin of said matrix in formation of the solid surface material.

2. The solid surface material of claim 1 wherein the resin is an acrylic resin.

3. The solid surface material of claim 1 wherein the resin is formed from a syrup comprised of an acrylic group polymer dissolved in a material selected from the group of an acrylic group monomer solution and a mixed monomer solution containing a vinyl monomer for copolymerization with an acrylic group monomer.

4. The solid surface material of claim 1 wherein the filler is present in the solid surface material in an amount from about 20 to about 65% by weight based on the total weight of said material.

5. The solid surface material of claim 4 wherein the filler comprises solid ceramic microspheres with a diameter from about 2 to 40 microns.

6. The solid surface material of claim 5 wherein the functional groups are formed from a silane.

7. A precursor to a solid surface material comprising a matrix of at least one resin and a ceramic microsphere filler dispersed in the matrix, said filler being coated with a composition having functional groups which are reactive with the resin of said matrix.

8. The precursor of claim 7 wherein the resin is an acrylic resin.

9. The precursor of claim 7 wherein the resin is in the form of a syrup comprised of an acrylic group polymer dissolved in a material selected from the group of an acrylic group monomer solution and a mixed monomer solution containing a vinyl monomer for copolymerization with an acrylic group monomer.

10. The precursor of claim 7 wherein the filler is present in the solid surface material in an amount from about 20 to about 65% by weight based on the total weight of said material.

11. The precursor of claim 10 wherein the filler comprises solid ceramic microspheres with a diameter from about 2 to 40 microns.

12. The precursor of claim 11 wherein the functional groups are formed from a silane.
